(19) United States
(12) Patent Application Publication
(10) Pub. No.: US 2019/0287304 A1
(43) Pub. Date: Sep. 19, 2019

(54) Safety Enhancement System for a Mobile Display System

(71) Applicant: The Boeing Company, Chicago, IL (US)

(72) Inventors: Paul Robert Davies, Long Beach, CA (US); Brian Dale Laughlin, Wichita, KS (US); Alexandra Marie White, Seattle, WA (US); Gregory Alan Garrett, O'Fallon, MO (US)

(21) Appl. No.: 15/919,898

(22) Filed: Mar. 13, 2018

(51) Int. Cl. G06T 19/00; G06T 7/73

(52) U.S. Cl. CPC G06T 19/006; G06T 2207/30196; G06T 7/75

(57) ABSTRACT

A method and system for safety enhancement. A movement of a user of a mobile display system that displays augmented reality information is measured. Movement information about the user is relayed from the movement measured for the user. A speed at which the user is moving with respect to a structure using the movement information and a three-dimensional model of the structure is determined. A visual display of the augmented reality information on the mobile display system is deactivated when the speed at which the user is moving with respect to the structure meets a deactivation condition.

### BACKGROUND INFORMATION

### 1. Field

The present disclosure relates generally to an improved computer system and, in particular, to a method, an apparatus, and a system to improve safety in displaying information on a head-mounted display.

### 2. Background

Augmented reality systems provide a live view of the physical real-world environment augmented by information displayed on the live view. The augmentation with additional information is provided by a computer system. This additional information can take various forms. For example, the additional information displayed can include text, a photograph, a video, a schematic diagram, graphical indicators, or other suitable types of information.

Augmented reality can be useful in many different applications such as gaming, education, and military. One specific application of augmented reality is providing instructions for performing tasks.

For example, a schematic diagram for a system can be displayed over a section of an aircraft where the system is to be installed or inspected if the system has already been installed. Additionally, graphical indicators can be displayed to bring attention to real-world elements viewed by the user. Additionally, other information such as instructions, graphical indicators identifying components, videos, or other suitable information can be displayed to guide the user in installing or inspecting the system.

In this manner, the augmented reality displayed to the user is a composite view of both the physical environment and virtual content. The physical environment is the live view, while the augmented reality information is the virtual content.

The live view may be provided as a video feed on a display or by using transparent, see-through displays or lenses, such that the user is able to see the physical environment through the display. For example, the live view can be seen on a display for a user device such as a head-mounted display or a tablet computer. The virtual content can be superimposed on this display. In other illustrative examples, the live view may be provided indirectly to a display in which other information is displayed to overlap the live view.

Although augmented reality provides an ability to guide a user to perform various tasks and provide needed information to perform the tasks, augmented reality systems can be hazardous. For example, a user can be distracted while moving within an aircraft, in a manufacturing cell, in a maintenance bay, or in some other area. The information augmenting the live view may include visual information that is distracting the user or reducing the vision of the user. The reduction in vision in manufacturing or maintenance areas is undesirable for safety reasons.

Therefore, it would be desirable to have a method and apparatus that take into account at least some of the issues discussed above, as well as other possible issues. For example, it would be desirable to have a method and apparatus that overcome a technical problem with displaying augmented reality information while a user is moving.

### SUMMARY

An embodiment of the present disclosure provides a safety enhancement system comprising a sensor system, a three-dimensional model of a structure, and a safety controller in communication with the sensor system. The sensor system is configured to measure a movement of a user of a mobile display system that displays augmented reality information and relay movement information about the user. The safety controller is configured to receive the movement information from the sensor system; determine a velocity at which the user is moving with respect to the structure using the movement information and the three-dimensional model of the structure; and deactivate a visual display of the augmented reality information on the mobile display system when a speed at which the user is moving with respect to the structure meets a deactivation condition.

Another embodiment of the present disclosure provides a method for safety enhancement. Movement information for a user of a mobile display system that displays augmented reality information is received by a safety controller. A speed at which the user is moving with respect to a structure using the movement information and a three-dimensional model of the structure is determined by the safety controller. A visual display of the augmented reality information on the mobile display system is deactivated by the safety controller when the speed at which the user is moving with respect to the structure meets a deactivation condition.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial illustration of a manufacturing environment in accordance with an illustrative embodiment;

FIG. 2 is an illustration of a block diagram of a manufacturing environment in accordance with an illustrative embodiment;

FIG. 3 is an illustration of a block diagram of conditions used to manage a visual display of augmented reality information on a mobile display system in accordance with an illustrative embodiment;

FIG. 4 is an illustration of a flowchart of a process for safety enhancement in accordance with an illustrative embodiment;

FIG. 5 is an illustration of a flowchart of a process for safety enhancement in accordance with an illustrative embodiment;

FIG. 6 is an illustration of a flowchart of a process for generating a warning for an undesired posture in accordance with an illustrative embodiment;

FIG. 7 is an illustration of a flowchart of a process for alerting a user of a hazardous location in accordance with an illustrative embodiment;

FIG. 8 is an illustration of a block diagram of a data processing system in accordance with an illustrative embodiment;

FIG. 9 is an illustration of a block diagram of an aircraft manufacturing and service method in accordance with an illustrative embodiment;

FIG. 10 is an illustration of a block diagram of an aircraft in which an illustrative embodiment may be implemented; and

FIG. 11 is an illustration of a block diagram of a product management system in accordance with an illustrative embodiment.

### DETAILED DESCRIPTION

The illustrative embodiments recognize and take into account one or more different considerations. The illustrative embodiments recognize and take into account that current mobile display systems, such as head-mounted displays, can result in undesired situations when used to display augmented reality information in a manufacturing environment. For example, the illustrative embodiments recognize and take into account that a user of a head-mounted display can be distracted from the environment around the user when viewing augmented reality information.

Additionally, the illustrative embodiments recognize and take into account that the display of augmented reality information may obscure a view of items in the environment that the user should be aware of when walking or moving within the environment. For example, the items can be a missing floor section, a portal without a door, an active lathe, or some other item.

Thus, the illustrative embodiments provide a method, an apparatus, and a system for safety enhancement. In one illustrative example, a movement of a user of a mobile display system that displays augmented reality information is measured. Movement information about the user from the movement measured for the user by a sensor system is relayed from the sensor system to a safety controller. A speed at which the user is moving is determined with respect to the structure using the movement information and a three-dimensional model of the structure. A visual display of augmented reality information on the mobile display system is deactivated by the safety controller when the speed at which the user is moving with respect to the structure meets a deactivation condition.

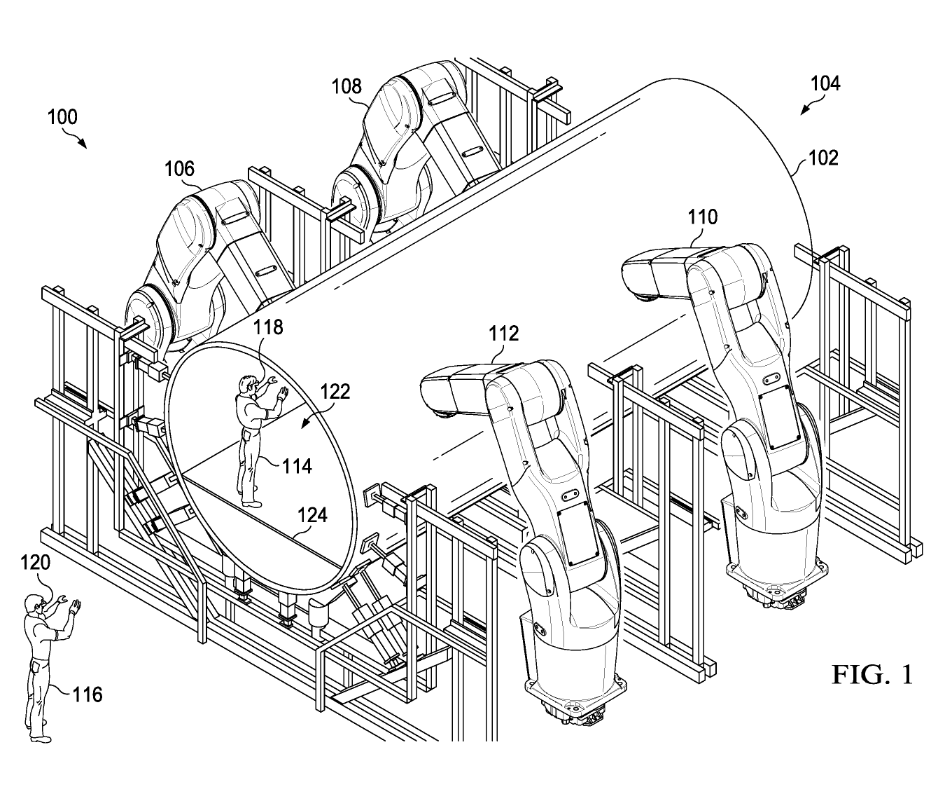

With reference now to the figures and, in particular, with reference to FIG. 1, a pictorial illustration of a manufacturing environment is depicted in accordance with an illustrative embodiment. In manufacturing environment 100, fuselage section 102 for an aircraft is located in work cell 104. As depicted, work cell 104 is an arrangement of resources in manufacturing environment 100 that is part of a process flow for manufacturing an aircraft.

In this illustrative example, manufacturing operations are performed on fuselage section 102 using resources in the form of automated equipment such as robotic arm 106, robotic arm 108, robotic arm 110, and robotic arm 112. These manufacturing operations may include at least one of machining, installation, painting, sealant application, inspection, or other suitable operations.

Further, human operator 114 and human operator 116 also perform manufacturing operations on fuselage section 102. For example, human operator 114 and human operator 116 may install wiring harnesses, perform inspections, or other operations on fuselage section 102.

As depicted, human operator 114 wears smart glasses 118, and human operator 116 wears smart glasses 120. Smart glasses 118 provide human operator 114 a live view of manufacturing environment 100. In a similar fashion, smart glasses 120 provides human operator 116 a live view of manufacturing environment 100. Additionally, augmented reality information is displayed on smart glasses 118 and smart glasses 120 to supplement the live view.

Augmented reality information can provide information about the manufacturing operations performed by human operator 114 and human operator 116. For example, the augmented reality information can list steps for tasks to be performed. Additionally, schematic diagrams and other information can be displayed on smart glasses 118 and smart glasses 120 to human operator 114 and human operator 116, respectively, in performing manufacturing operations.

In this illustrative example, human operator 114 and human operator 116 are located in positions with respect to fuselage section 102. For example, human operator 114 may move within interior 122 of fuselage section 102. As depicted, human operator 116 may move outside of fuselage section 102 and may move with respect to other structures such as robotic arm 106, robotic arm 108, robotic arm 110, and robotic arm 112.

As depicted, when human operator 114 moves within interior 122 of fuselage section 102, the display of augmented reality information on smart glasses 118 can distract human operator 114 from hazardous locations within interior 122 of fuselage section 102. For example, floor 124 may have missing sections that human operator 114 may miss when viewing augmented reality information on smart glasses 118. In other illustrative examples, human operator 114 may pay attention to manufacturing environment 100, but the augmented reality information may obscure hazardous locations in interior 122 of fuselage section 102. Human operator 116 may also be distracted from hazardous location within manufacturing environment 100 relative to structures such as fuselage section 102, robotic arm 106, robotic arm 108, robotic arm 110, and robotic arm 112. The display of the augmented reality information with the live view can distract human operator 116 or obscure hazards within manufacturing environment 100.

In this illustrative example, smart glasses 118 is configured to provide safety enhancement to human operator 114, and smart glasses 120 is configured to provide safety enhancement to human operator 116. The smart glasses are configured to deactivate the visual display of the augmented reality information when the human operators move faster than some threshold level. The threshold level may be a speed greater than zero or some other speed, depending on the particular implementation.

The illustration of manufacturing environment 100 in FIG. 1 is not meant to imply limitations to the manner in which other manufacturing environments can be implemented in accordance with an illustrative embodiment. For example, other types of automated equipment may be present in work cell 104 other than the robotic arms. These other types of automated equipment may include, for example, crawlers on flex tracks, drones, or other suitable types of automated equipment. Further, these processes can form other types of structures other than fuselage section 102. In other illustrative examples, the manufacturing operations can be performed on a wing, an aircraft engine, a skin panel, a nearly completed aircraft, or other types of structures. The illustrative examples also be used in other locations other than work cell 104. For example, the safety enhancements can be provided to human operator 114 and human operator 116 working in a building, on a bridge, or in some other location.

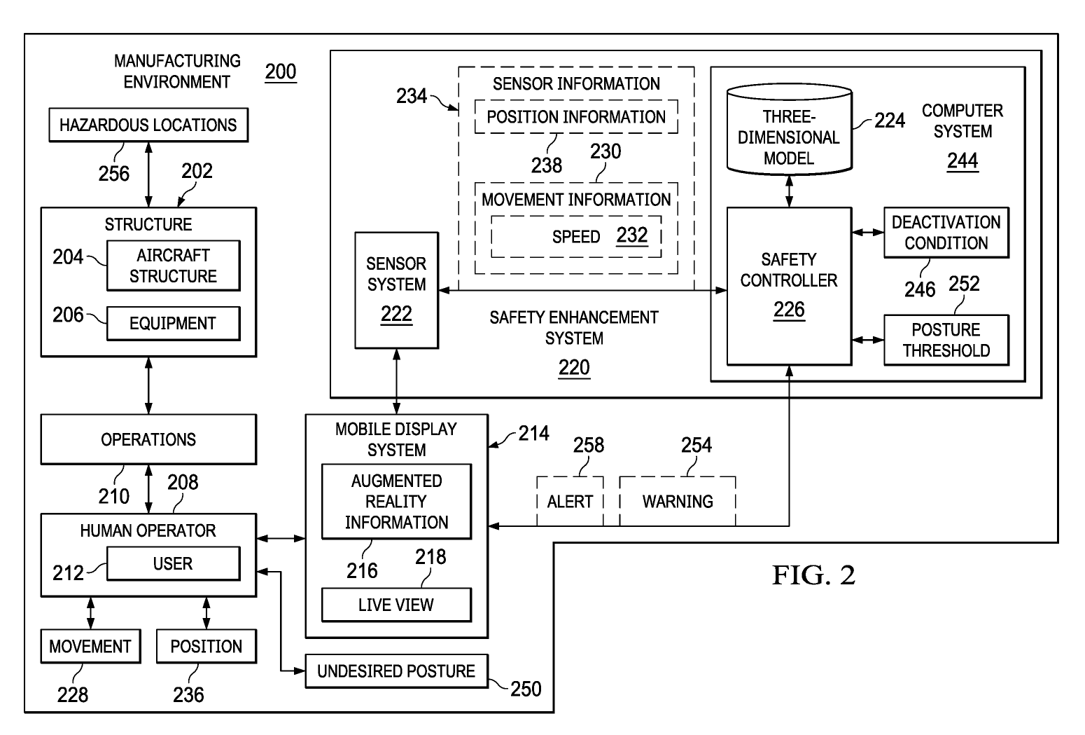

With reference now to FIG. 2, an illustration of a block diagram of a manufacturing environment is depicted in accordance with an illustrative embodiment. In this illustrative example, manufacturing environment 100 in FIG. 1 is an example of one implementation for manufacturing environment 200 shown in block form in FIG. 2.

In this particular example, manufacturing environment 200 contains structure 202. As depicted, structure 202 is aircraft structure 204. Aircraft structure 204 may take various forms. For example, aircraft structure 204 may be an aircraft in an uncompleted state, a fuselage section, an engine housing, a wing box, a wing, or some other suitable type of aircraft structure.

In other illustrative examples, structure 202 can take the form of equipment 206. For example, equipment 206 can be at least one of a platform, a table, a press, a crawler, a drone, a robotic device, a robotic arm, a lathe, or some other suitable type of equipment.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, human operator 208 performs operations 210 on structure 202. As depicted, human operator 208 is user 212 of mobile display system 214. In this illustrative example, mobile display system 214 is selected from a group comprising a head-mounted display, smart glasses, a mobile phone, a tablet computer, and some other suitable types of mobile display systems.

Mobile display system 214 displays augmented reality information 216 to user 212. Augmented reality information 216 is displayed over live view 218 on mobile display system 214. Augmented reality information 216 can be selected from at least one of instructions, a checklist, a schematic, a diagram, an image, a video, or other types of information that can aid user 212 in performing operations 210.

In this illustrative example, live view 218 is seen by user 212 on mobile display system 214. Live view 218 can be directly seen through mobile display system 214 or indirectly using a camera that displays images.

Safety enhancement system 220 provides enhanced safety for user 212 in manufacturing environment 200 when user 212 uses mobile display system 214. As depicted, safety enhancement system 220 comprises sensor system 222, three-dimensional model 224, and safety controller 226.

Sensor system 222 is a hardware system and is configured to measure movement 228 of user 212 of mobile display system 214 that displays augmented reality information 216. Sensor system 222 is configured to generate sensor information 234, which includes movement information 230 about user 212. Sensor information 234 is generated in real-time and used to estimate walking speed, orientation, posture, and other information about user 212. Sensor information 234 generated by sensor system 222 is relayed to safety controller 226 in computer system 244 for processing.

In this depicted example, movement information 230 includes speed 232 of user 212. Sensor system 222 is also configured to measure position 236 of user 212 and generate position information 238. In this example, position information 238 includes a location of user 212 in three dimensions and an orientation of user 212. Position information 238 is relayed to safety controller 226 for processing.

As depicted, sensor system 222 can be part of mobile display system 214. For example, sensor system 222 can be integrated within a housing for mobile display system 214. Sensor system 222 is selected from at least one of an accelerometer, a gyroscope, a magnetometer, a global positioning system device, a camera, or some other suitable sensor device. In other words, sensor system 222 can have more than more than one type of sensor and more than one sensor of the same type in these illustrative examples.

In this particular example, three-dimensional model 224 and safety controller 226 are located in computer system 244. Computer system 244 is a physical hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system.

Three-dimensional model 224 is an electronic model of structure 202. Three-dimensional model 224 can be a computer-aided design (CAD) model or some other suitable type of model that can be accessed and used by safety controller 226.

In this illustrative example, safety controller 226 is in communication with sensor system 222. Safety controller 226 is configured to receive movement information 230 from sensor system 222 and determine speed 232 at which user 212 is moving with respect to structure 202 using movement information 230 and three-dimensional model 224 of structure 202.

Safety controller 226 deactivates a visual display of augmented reality information 216 on mobile display system 214 when speed 232 at which user 212 is moving with respect to structure 202 meets deactivation condition 246. This condition can take a number of different forms. For example, deactivation condition 246 can be a parameter, a threshold value, a rule, or some other suitable description of when the display of augmented reality information 216 should be deactivated.

In deactivating the visual display of augmented reality information 216 on mobile display system 214, safety controller 226 may cause a blank display to appear on mobile display system 214 when speed 232 at which user 212 is moving with respect to structure 202 meets deactivation condition 246. In another illustrative example, safety controller 226 may deactivate the visual display of augmented reality information 216 on mobile display system 214 by removing the visual display of augmented reality information 216 while continuing to display live view 218 when speed 232 at which user 212 is moving with respect to structure 202 meets deactivation condition 246.

As depicted, safety controller 226 is configured to resume the visual display of augmented reality information 216 when speed 232 at which user 212 is moving with respect to structure 202 no longer meets deactivation condition 246. In yet another illustrative example, the resumption of the visual display of augmented reality information 216 can be based on another condition or rule that is different from deactivation condition 246. For example, if the visual display is deactivated in response to speed 232 exceeding the threshold in deactivation condition 246, a different threshold or requirement can be specified in another condition for resuming the visual display of augmented reality information 216.

In the illustrative example, safety controller 226 may be implemented in software, hardware, firmware, or a combination thereof. When software is used, the operations performed by safety controller 226 may be implemented in program code configured to run on hardware, such as a processor unit. When firmware is used, the operations performed by safety controller 226 may be implemented in program code and data and stored in persistent memory to run on a processor unit. When hardware is employed, the hardware may include circuits that operate to perform the operations in safety controller 226.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In another illustrative example, safety controller 226 can provide additional safety enhancement with respect to ergonomics. For example, safety controller 226 can be configured to determine whether user 212 is in undesired posture 250 using position information 238, determine whether user 212 has been in undesired posture 250 for a period of time that is greater than posture threshold 252 for undesired posture 250, and generate warning 254 to user 212. Further, safety controller 226 can turn off mobile display system 214 if user 212 does not move out of undesired posture 250 after a selected period of time. When user 212 remains in undesired posture 250, user 212 is in a static state, such as a head or limb remaining in the same position for five minutes, ten minutes, or some other period of time that results in poor ergonomics for user 212.

In another illustrative example, safety controller 226 can provide yet another type of safety enhancement to user 212 with respect to potential hazards. When sensor system 222 is configured to measure position 236 of user 212 and generate position information 238 from position 236 measured for user 212, safety controller 226 can warn user 212 of hazardous locations 256 in manufacturing environment 200.

In this illustrative example, safety controller 226 is configured to determine position 236 of user 212 with respect to structure 202 using position information 238 and three-dimensional model 224. Safety controller 226 can identify a number of hazardous locations 256 with respect to structure 202 using three-dimensional model 224 and generate alert 258 for a hazardous location in the number of hazardous locations 256 when user 212 is within an undesired distance from the hazardous location using position 236 of user 212 with respect to structure 202 and using three-dimensional model 224.

In one illustrative example, one or more technical solutions are present that overcome a technical problem with displaying augmented reality information while a user is moving. As a result, one or more technical solutions may provide a technical effect of enhancing user safety for a user of a mobile display system in which the visual display of the augmented reality information is disabled when the user moves at a speed that meets a deactivation condition. One or more technical solutions can also enable reducing poor posture in the workplace by enabling warning a user of an undesired position that has been present more than a desired amount of time. One or more technical solutions also can alert the user of hazardous locations for structures.

As a result, computer system 244 operates as a special purpose computer system in which safety controller 226 in computer system 244 enables improving the manner in which mobile display system 214 provides safety enhancements for user 212. In particular, safety controller 226 transforms computer system 244 into a special purpose computer system as compared to currently available general computer systems that do not have safety controller 226.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, safety controller 226 can be implemented in other environments in addition to or in place of manufacturing environment 200. For example, in the illustrative example, safety controller 226 can be implemented in a maintenance environment.

Further, structure 202 can take other forms other than aircraft structure 204. For example, structure 202 can be selected from one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a house, a manufacturing facility, a manufacturing cell, and other types of structures, components, or assemblies for the structures. These structures may be in an uncompleted state.

Further, safety controller 226 can determine speed 232 using information other than movement information 230. For example, safety controller 226 can determine speed 232 from changes in position 236 of user 212 over time in position information 238. In yet another illustrative example, sensor system 222 can be a component that is external to safety enhancement system 220.

As another example, three-dimensional model 224 may be located in another computer system outside of computer system 244. Further, three-dimensional model 224 can be located on a different data processing system in computer system 244 from safety controller 226. In yet another illustrative example, safety controller 226 may be part of mobile display system 214 and three-dimensional model 224 can be located on a server computer in computer system 244. In yet another example, mobile display system 214 may be part of computer system 244.

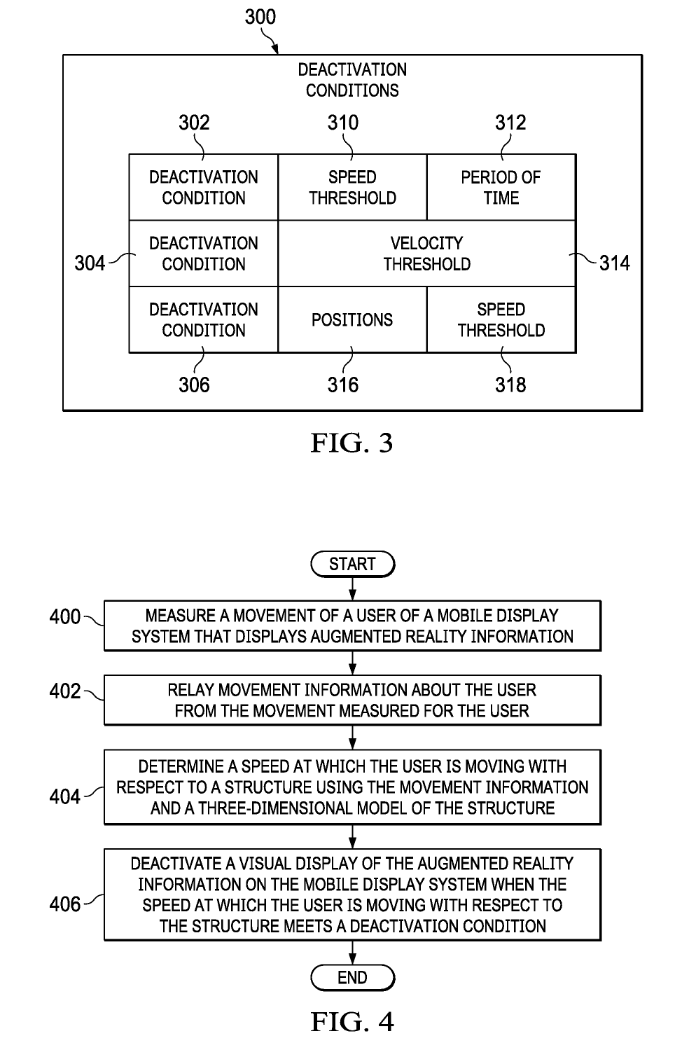

With reference next to FIG. 3, an illustration of a block diagram of conditions used to manage a visual display of augmented reality information on a mobile display system is depicted in accordance with an illustrative embodiment. In this figure, deactivation conditions 300 are examples of conditions that can be used to implement deactivation condition 246 in FIG. 2. Deactivation conditions 300 are conditions that cause ceasing a display of augmented reality information on a mobile display system. The display of the augmented reality information can be resumed when the deactivation condition is no longer met, when another condition for reactivating the visual display is met, or some combination thereof.

In this illustrative example, deactivation conditions 300 can take a number of different forms. As depicted, deactivation conditions 300 include deactivation condition 302, deactivation condition 304, and deactivation condition 306.

As depicted, deactivation condition 302 comprises speed threshold 310 and period of time 312. In this illustrated example, the display of the augmented reality information is ceased when the speed of the user exceeds speed threshold 310 for period of time 312.

Speed threshold 310 can take a number of different forms. For example, speed threshold 310 can be zero miles per hour, one mile per hour, or some other amount of speed. Period of time 312 defines the amount time that is needed while speed threshold 310 has been exceeded to satisfy deactivation condition 302. Period of time 312 may be, for example, zero seconds, ten seconds, one minute, or some other suitable period of time.

As depicted, deactivation condition 304 includes velocity threshold 314. In this illustrative example, velocity threshold 314 uses a vector to define a particular speed at which the user moves as well as a direction of travel that is needed to meet deactivation condition 304. In this illustrative example, the direction of travel is a direction with respect to the structure. For example, the direction of travel may be towards the structure.

As depicted, deactivation condition 306 includes positions 316 and speed threshold 318 as parameters. In this illustrative example, positions 316 may be at least one of positions within the structure or positions within a selected distance of the structure. Speed threshold 318 is a speed at which the user should not exceed. With deactivation condition 306, the display of the augmented reality information on mobile display devices is deactivated if the user moves faster than speed threshold 318 while within positions 316, such as within the structure or within a selected distance from the structure.

The illustration of deactivation conditions 300 in FIG. 3 is only meant to be illustrative examples of some implementations for deactivation condition 246 used by safety controller 226 in FIG. 2. These illustrations are not meant to limit the manner in which deactivation condition 246 can be implemented in other illustrative examples.

Turning next to FIG. 4, an illustration of a flowchart of a process for safety enhancement is depicted in accordance with an illustrative embodiment. The process illustrated in FIG. 4 can be implemented in at least one of hardware or software in safety enhancement system 220 in FIG. 2.

The process begins by measuring a movement of a user of a mobile display system that displays augmented reality information (operation 400). The measurement in operation 400 is performed using a sensor system for the mobile display system.

The process relays movement information about the user from the movement measured for the user (operation 402). Operation 402 also can be performed using the sensor system.

The process determines a speed at which the user is moving with respect to a structure using the movement information and a three-dimensional model of the structure (operation 404). This operation and the subsequent operations in this flowchart can be performed by safety controller 226 in safety enhancement system 220 in FIG. 2.

The process deactivates a visual display of the augmented reality information on the mobile display system when the speed at which the user is moving with respect to the structure meets a deactivation condition (operation 406). The movement with respect to the structure can be moving towards the structure, away from the structure, on the structure, inside of the structure, or some combination thereof. The process terminates thereafter.

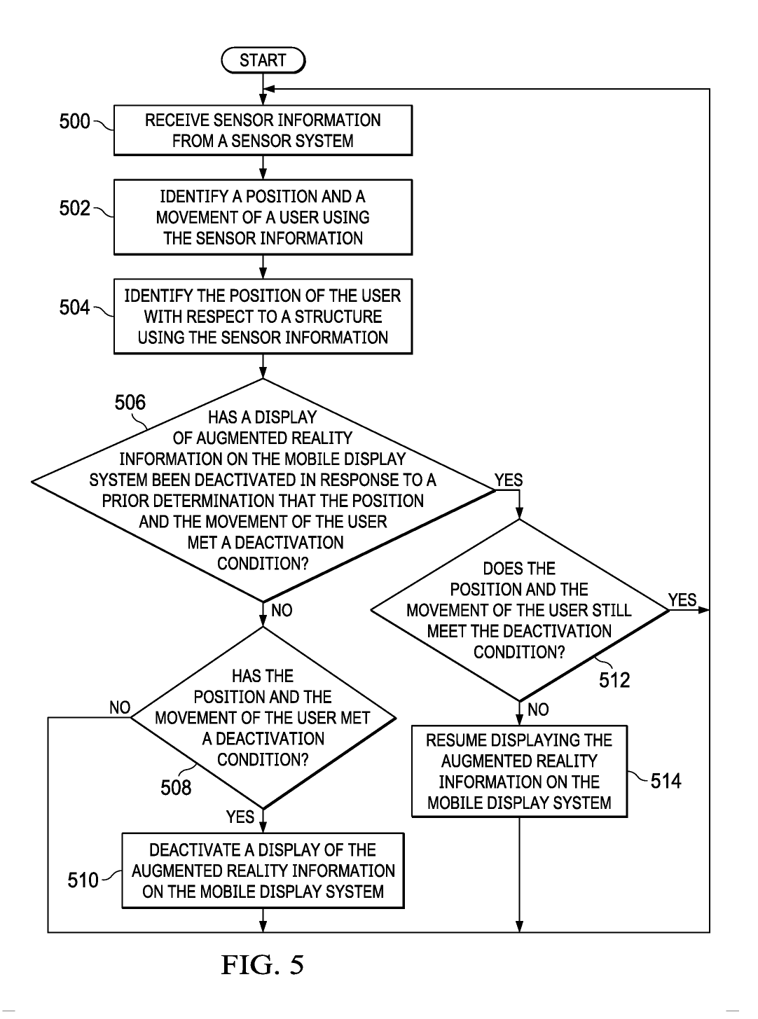

With reference to FIG. 5, an illustration of a flowchart of a process for safety enhancement is depicted in accordance with an illustrative embodiment. The process illustrated in FIG. 5 can be implemented in at least one of hardware or software in computer system 244 in FIG. 2. The operations can be implemented in safety controller 226 in computer system 244 in FIG. 2.

The process begins by receiving sensor information from a sensor system (operation 500). The sensor information received in operation 500 can be at least one of movement information or position information.

The process identifies a position and a movement of a user using the sensor information (operation 502). In this illustrative example, the position may include an orientation of the user. For example, when a mobile display system is a pair of smart glasses, the orientation may indicate the angle at which the head of the user is tilted.

Further, the position includes altitude and may indicate whether the user is standing, kneeling, or prone. In this example, the movement of the user may be a speed or a velocity of the user.

The process identifies the position of the user with respect to a structure using the sensor information (operation 504). The position of the user can be identified using a three-dimensional model of the structure.

The position of the user relative to the structure can be identified using a coordinate system for the structure. For example, if the structure is an aircraft, the position may be defined in aircraft coordinates for the aircraft. The coordinate system can be a Cartesian coordinate system, a polar coordinate system, or some type of coordinate system. The identification of the position of the user relative to the structure can be performed using any number of currently available techniques.

For example, the user may calibrate the location of the mobile display device by scanning a barcode, reading a radio frequency identification (RFID) tag, or some other indicator at a location for the structure. In another example, a camera may generate images of features in the structure with those images being used to identify the location of the user within the structure.

By knowing the location of the mobile display device, the movement of the user relative to the structure using the mobile display device can be identified. Next, a determination is made as to whether a display of augmented reality information on the mobile display system has been deactivated in response to a prior determination that the position and the movement of the user met a deactivation condition (operation 506). If the display of the augmented reality information on the mobile display system has not been deactivated, a determination is made as to whether the position and the movement of the user has met a deactivation condition (operation 508). If the position and the movement of the user has met the deactivation condition, the process returns to operation 500. The deactivation condition may be, for example, one of deactivation conditions 300 in FIG. 3.

If the deactivation condition has been met in operation 508, the process deactivates a display of the augmented reality information on the mobile display system (operation 510). The process then returns to operation 500.

With reference again to operation 506, if the display of the augmented reality information on the mobile display system has been deactivated, a determination is made as to whether the position and the movement of the user still meets the deactivation condition (operation 512). If the deactivation condition is no longer met, the process resumes displaying the augmented reality information on the mobile display system (operation 514). The process then returns to operation 500, as described above.

Otherwise, if the deactivation condition is met in operation 512, the process returns to operation 500, as described above. With reference again to operation 508, if the position and the movement of the user has not met the deactivation condition, the process also returns to operation 500.

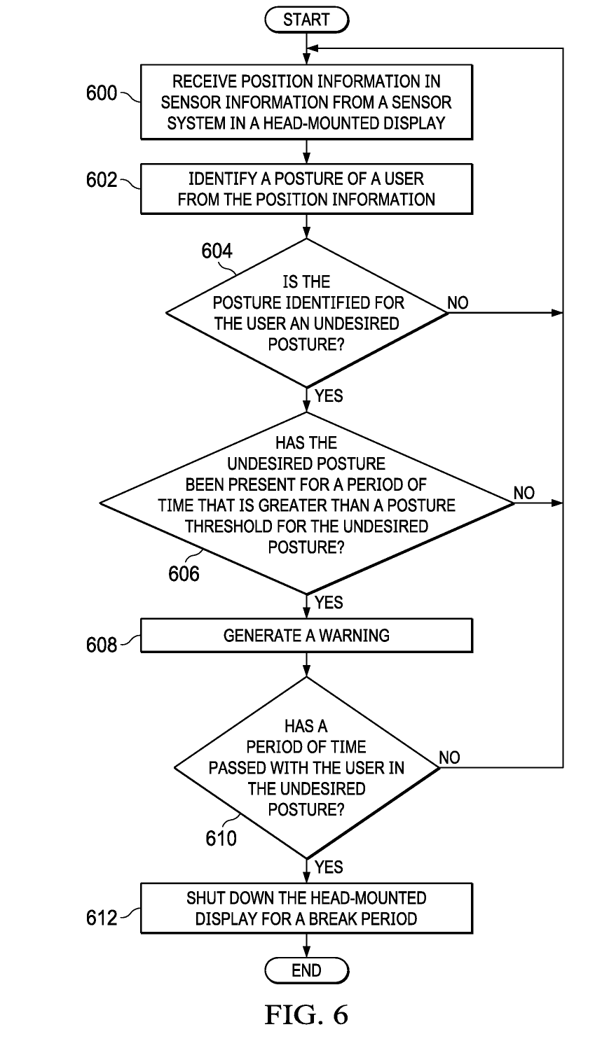

With reference now to FIG. 6, an illustration of a flowchart of a process for generating a warning for an undesired posture is depicted in accordance with an illustrative embodiment. The process illustrated in FIG. 6 can be implemented in at least one of hardware or software in computer system 244 in FIG. 2. The operations can be implemented in safety controller 226 in computer system 244 in FIG. 2. This process can be implemented in a mobile display device, such as a head-mounted display.

The process begins by receiving position information in sensor information from a sensor system in a head-mounted display (operation 600). For example, an inclinometer in the sensor system can detect flexion or extension of the neck of a user and send this information as part of the position information.

The process identifies a posture of a user from the position information (operation 602). In operation 602, the process can identify the posture of the user from an orientation of the mobile display system. For example, if the mobile display system is a pair of smart glasses, the orientation can indicate the tilt of the head of the user as an example of the posture for the user. Further, an altitude in the position information can be used to determine whether the user is standing, kneeling, or prone as other postures for the user.

A determination is made as to whether the posture identified for the user is an undesired posture (operation 604). For example, the undesired posture may be a neck flexion for the user that is greater than 20 degrees. If the posture is an undesired posture in operation 604, the process determines whether the undesired posture has been present for a period of time that is greater than a posture threshold for the undesired posture (operation 606).

If the undesired posture is present for a period of time greater than the posture threshold for the undesired posture, the process generates a warning (operation 608). This warning can take a number of forms. For example, the warning can be a graphical indicator displayed on the mobile display system such as text, a graphic, or some other graphical indicator indicating that an undesired position is present. In another illustrative example, the warning can take the form of an audible warning in addition to or in place of the display of the graphical indicator.

A determination is made as to whether a period of time has passed with the user in the undesired posture (operation 610). If the period of time has passed, the process shuts down the head-mounted display for a break period (operation 612). The process terminates thereafter. Otherwise, if the period of time has not passed in operation 610, the process returns to operation 600. The break period may be, for example, five minutes, 15 minutes, or some other suitable period of time needed for a break. The break period may be based on the particular undesired posture.

With reference again operation 604, if the posture identified for the user is not the undesired posture, the process returns to operation 600. Turning back to operation 606, if the undesired posture has not been present for a period of time greater than the posture threshold for the undesired posture, the process also returns to operation 600, as described above.

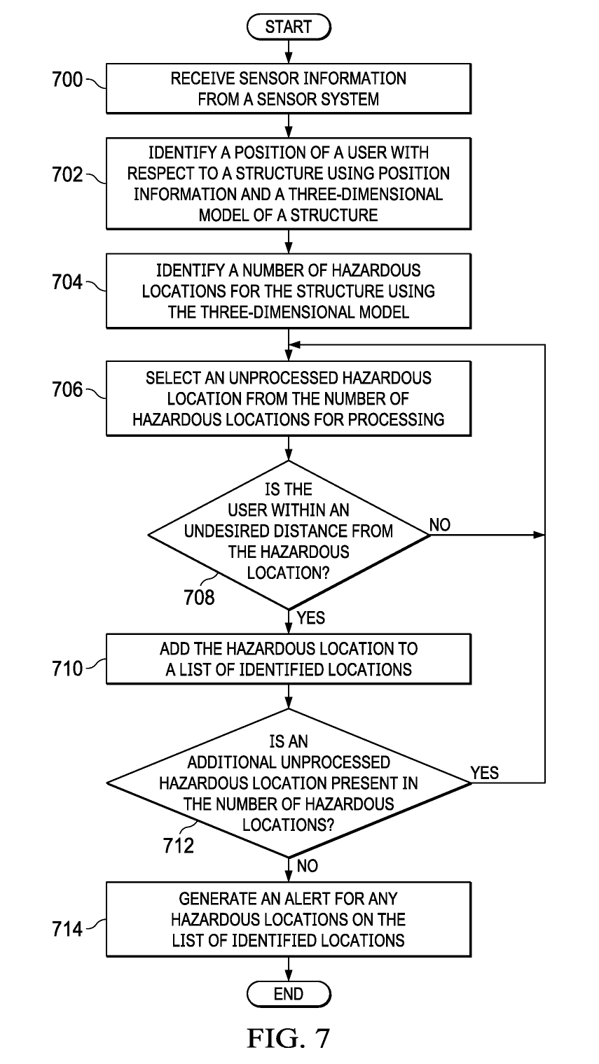

With reference next to FIG. 7, an illustration of a flowchart of a process for alerting a user of a hazardous location is depicted in accordance with an illustrative embodiment. The process illustrated in FIG. 7 can be implemented in at least one of hardware or software in computer system 244 in FIG. 2. The operations can be implemented in safety controller 226 in computer system 244 in FIG. 2. This process can be implemented in a mobile display device, such as a head-mounted display.

The process begins by receiving sensor information from a sensor system (operation 700). In this illustrative example, the sensor information includes position information used to identify a position of a user of a mobile display system.

The process identifies a position of a user with respect to a structure using position information and a three-dimensional model of a structure (operation 702). In operation 702, the three-dimensional model of the structure indicates a current state of the structure. For example, the three-dimensional model can reflect the state of assembly of an aircraft on a line in a manufacturing facility.

The position of the user can be described with respect to a coordinate system for the structure defined in the three-dimensional model of the structure. The position of the user can be described using three-dimensional coordinates such as latitude, longitude, and altitude. In other illustrative examples, a polar coordinate system could be used. Further, the position of the user can also include an orientation or direction that the user faces based on the mobile display system.

The process identifies a number of hazardous locations for the structure using the three-dimensional model (operation 704). These hazardous locations may be located inside of the structure, outside of the structure, or within some selected distance of the structure.

The process selects an unprocessed hazardous location from the number of hazardous locations for processing (operation 706). The process determines whether the user is within an undesired distance from the hazardous location (operation 708). If the user is within the undesired distance from the hazardous location, the hazardous location is added to a list of identified locations (operation 710).

The process then determines whether an additional unprocessed hazardous location is present in the number of hazardous locations (operation 712). If an additional unprocessed hazardous location is present, the process returns to operation 706.

Otherwise, the process generates an alert for any hazardous locations on the list of identified locations (operation 714). The alert can take a number of different forms. For example, the alert can be displayed on the mobile display system. This alert can take the form of a message, text, a graphical indicator, or some other suitable type of alert. For example, a graphical indicator may be displayed to highlight or draw attention to the hazardous location when the hazardous location can be seen in the live view. The alert may be audible in addition to being displayed on the mobile display system. The process terminates thereafter. With reference again to operation 708, if the user is not within the undesired distance from the hazardous location, the process returns to operation 706, as described above.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, the process in FIG. 5 can identify a velocity in addition to speed 232 of the user. Speed 232 and direction of travel can be used to determine whether the velocity of the user meets the deactivation condition.

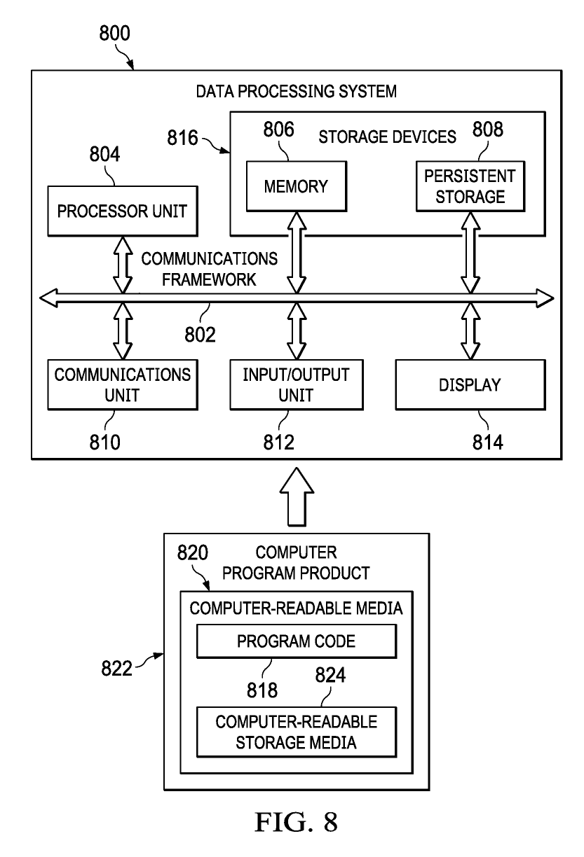

Turning now to FIG. 8, an illustration of a block diagram of a data processing system is depicted in accordance with an illustrative embodiment. Data processing system 800 may be used to implement computer system 244 in FIG. 2. In this illustrative example, data processing system 800 includes communications framework 802, which provides communications between processor unit 804, memory 806, persistent storage 808, communications unit 810, input/output unit 812, and display 814. In this example, communications framework 802 may take the form of a bus system.

Processor unit 804 serves to execute instructions for software that may be loaded into memory 806. Processor unit 804 may be a number of processors, a multi-processor core, or some other type of processor, depending on the particular implementation.

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, may be, for example, a random-access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a solid-state drive (SSD), a flash memory, a rewritable optical disk, a rewritable magnetic tape, or some combination of the above. The media used by persistent storage 808 also may be removable. For example, a removable hard drive may be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer usable program code, or computer-readable program code that may be read and executed by a processor in processor unit 804. The program code in the different embodiments may be embodied on different physical or computer-readable storage media, such as memory 806 or persistent storage 808.

Program code 818 is located in a functional form on computer-readable media 820 that is selectively removable and may be loaded onto or transferred to data processing system 800 for execution by processor unit 804. Program code 818 and computer-readable media 820 form computer program product 822 in these illustrative examples. In the illustrative example, computer-readable media 820 is computer-readable storage media 824.

In these illustrative examples, computer-readable storage media 824 is a physical or tangible storage device used to store program code 818 rather than a medium that propagates or transmits program code 818.

Alternatively, program code 818 may be transferred to data processing system 800 using a computer-readable signal media. The computer-readable signal media may be, for example, a propagated data signal containing program code 818. For example, the computer-readable signal media may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code 818.

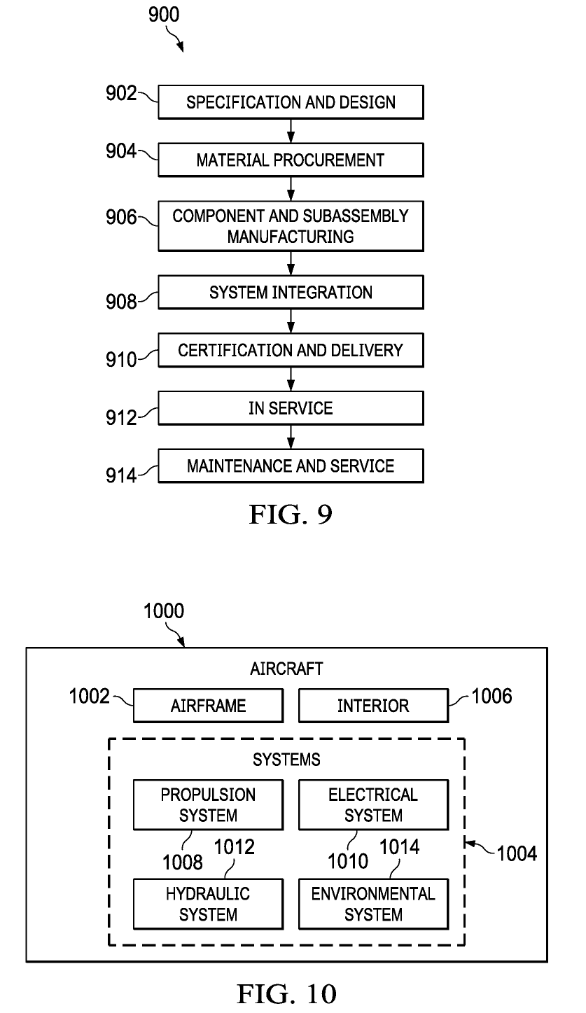

Illustrative embodiments of the disclosure may be described in the context of aircraft manufacturing and service method 900 as shown in FIG. 9 and aircraft 1000 as shown in FIG. 10. Turning first to FIG. 9, an illustration of a block diagram of an aircraft manufacturing and service method is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 in FIG. 10 takes place. Thereafter, aircraft 1000 in FIG. 10 in may go through certification and delivery 910 in order to be placed in service 912. While in service 912 by a customer, aircraft 1000 in FIG. 10 is scheduled for routine maintenance and service 914, which may include modification, reconfiguration, refurbishment, and other maintenance or service.

Each of the processes of aircraft manufacturing and service method 900 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of a block diagram of an aircraft is depicted in which an illustrative embodiment may be implemented. In this example, aircraft 1000 is produced by aircraft manufacturing and service method 900 in FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 900 in FIG. 9. For example, increased safety can be provided to users of mobile display systems when the users perform manufacturing or maintenance operations.

Further, the increased safety can be enabled during any phase of aircraft manufacturing and service method 900 in FIG. 9 when mobile display systems are used that involve the display of augmented reality information. For example, safety controller 226 in FIG. 2 can be implemented during any of these phases to control the visual display of augmented reality information on mobile display systems in a manner that increases safety for human operators of the mobile display systems.

In one illustrative example, components or subassemblies produced in component and subassembly manufacturing 906 in FIG. 9 may be fabricated or manufactured in a manner similar to components or subassemblies produced while aircraft 1000 is in service 912 in FIG. 9. As yet another example, one or more apparatus embodiments, method embodiments, or a combination thereof may be utilized during production stages, such as component and subassembly manufacturing 906 and system integration 908 in FIG. 9. One or more apparatus embodiments, method embodiments, or a combination thereof may be utilized while aircraft 1000 is in service 912, during maintenance and service 914 in FIG. 9, or both. The use of a number of the different illustrative embodiments may substantially expedite the assembly of aircraft 1000, reduce the cost of aircraft 1000, or both expedite the assembly of aircraft 1000 and reduce the cost of aircraft 1000.

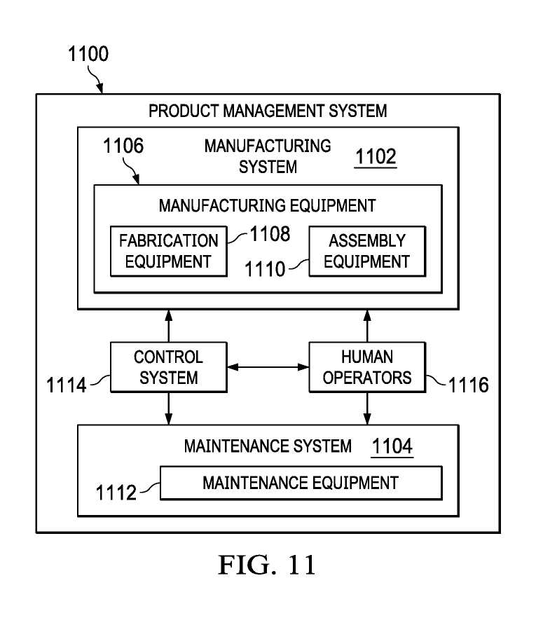

Turning now to FIG. 11, an illustration of a block diagram of a product management system is depicted in accordance with an illustrative embodiment. Product management system 1100 is a physical hardware system. In this illustrative example, product management system 1100 may include at least one of manufacturing system 1102 or maintenance system 1104.

Manufacturing system 1102 is configured to manufacture products, such as aircraft 1000 in FIG. 10. As depicted, manufacturing system 1102 includes manufacturing equipment 1106. Manufacturing equipment 1106 includes at least one of fabrication equipment 1108 or assembly equipment 1110.

Fabrication equipment 1108 is equipment that may be used to fabricate components for parts used to form aircraft 1000 in FIG. 10. For example, fabrication equipment 1108 may include machines and tools. These machines and tools may be at least one of a drill, a hydraulic press, a furnace, a mold, a composite tape laying machine, a vacuum system, a lathe, or other suitable types of equipment. Fabrication equipment 1108 may be used to fabricate at least one of metal parts, composite parts, semiconductors, circuits, fasteners, ribs, skin panels, spars, antennas, or other suitable types of parts.

Assembly equipment 1110 is equipment used to assemble parts to form aircraft 1000 in FIG. 10. In particular, assembly equipment 1110 may be used to assemble components and parts to form aircraft 1000 in FIG. 10. Assembly equipment 1110 also may include machines and tools. These machines and tools may be at least one of a robotic arm, a crawler, a faster installation system, a rail-based drilling system, or a robot. Assembly equipment 1110 may be used to assemble parts such as seats, horizontal stabilizers, wings, engines, engine housings, landing gear systems, and other parts for aircraft 1000 in FIG. 10.

In this illustrative example, maintenance system 1104 includes maintenance equipment 1112. Maintenance equipment 1112 may include any equipment needed to perform maintenance on aircraft 1000 in FIG. 10 in FIG. 10. Maintenance equipment 1112 may include tools for performing different operations on parts on aircraft 1000 in FIG. 10. These operations may include at least one of disassembling parts, refurbishing parts, inspecting parts, reworking parts, manufacturing replacement parts, or other operations for performing maintenance on aircraft 1000. These operations may be for routine maintenance, inspections, upgrades, refurbishment, or other types of maintenance operations.

In the illustrative example, maintenance equipment 1112 may include ultrasonic inspection devices, x-ray imaging systems, vision systems, drills, crawlers, and other suitable device. In some cases, maintenance equipment 1112 may include fabrication equipment 1108, assembly equipment 1110, or both to produce and assemble parts that may be needed for maintenance.

Product management system 1100 also includes control system 1114. Control system 1114 is a hardware system and may also include software or other types of components. Control system 1114 is configured to control the operation of at least one of manufacturing system 1102 or maintenance system 1104. In particular, control system 1114 may control the operation of at least one of fabrication equipment 1108, assembly equipment 1110, or maintenance equipment 1112.

The hardware in control system 1114 may be using hardware that may include computers, circuits, networks, and other types of equipment. The control may take the form of direct control of manufacturing equipment 1106. For example, robots, computer-controlled machines, and other equipment may be controlled by control system 1114. In other illustrative examples, control system 1114 may manage operations performed by human operators 1116 in manufacturing or performing maintenance on aircraft 1000 in FIG. 10. For example, control system 1114 may assign tasks, provide instructions, display models, or perform other operations to manage operations performed by human operators 1116.

In these illustrative examples, safety controller 226 in FIG. 2 may be implemented in control system 1114 to manage at least one of the manufacturing or maintenance of aircraft 1000 in FIG. 10. Safety controller 226 in FIG. 2 can be implemented to control the display of augmented reality information on mobile display systems in at least one of manufacturing equipment 1106 or maintenance equipment 1112. For example, a safety controller can be implemented in control system 1114 to control mobile display systems in manufacturing equipment 1106 or maintenance equipment 1112 used by human operators 1116.

In the different illustrative examples, human operators 1116 may operate or interact with at least one of manufacturing equipment 1106, maintenance equipment 1112, or control system 1114. This interaction may be performed to manufacture or perform maintenance on aircraft 1000 in FIG. 10 using mobile display systems with increased safety for the implementation of control system 1114.

Of course, product management system 1100 may be configured to manage other products other than aircraft 1000 in FIG. 10. Although product management system 1100 has been described with respect to manufacturing in the aerospace industry, product management system 1100 may be configured to manage products for other industries. For example, product management system 1100 can be configured to manufacture products for the automotive industry as well as any other suitable industries.

Thus, the illustrative embodiments provide a method, an apparatus, and a system for safety enhancement. In one illustrative example, a movement of a user of a mobile display system that displays augmented reality information is measured. Movement information about the user is relayed from the movement measured for the user. A speed at which the user is moving is determined with respect to the structure using the movement information and a three-dimensional model of the structure. A visual display of the augmented reality information on the mobile display system is deactivated when the speed at which the user is moving with respect to the structure meets a deactivation condition.

In the illustration examples, one or more technical solutions may provide a technical effect that enhances user safety for a user of a mobile display system in which the display of the augmented reality information is disabled when the user moves at a speed that meets a deactivation condition. One or more technical solutions can also enable reducing poor posture in the workplace by enabling warning a user of an undesired position that has been present more than a desired amount of time. Additionally, one or more technical solutions in the depicted examples also can alert the user of hazardous locations for the structure. This illustrative example provides a technical effect of increasing awareness of the user to surroundings in an environment such as a manufacturing or maintenance environment. The increased awareness increases safety for the user or other human operators in a manufacturing or maintenance environment.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A safety enhancement system comprising:
a sensor system configured to measure a movement of a user of a mobile display system that displays augmented reality information and relay movement information about the user;
a three-dimensional model of a structure; and
a safety controller in communication with the sensor system, wherein the safety controller is configured to receive the movement information from the sensor system; determine a velocity at which the user is moving with respect to the structure using the movement information and the three-dimensional model of the structure; and deactivate a visual display of the augmented reality information on the mobile display system when a speed at which the user is moving with respect to the structure meets a deactivation condition.

2. The safety enhancement system of claim 1, wherein the safety controller determines a location of the user with respect to the structure; and deactivates the visual display of the augmented reality information on the mobile display system when the speed at which the user is moving and the location of the user with respect to the structure meets the deactivation condition.

3. The safety enhancement system of claim 1, wherein in deactivating the visual display of the augmented reality information on the mobile display system when the speed at which the user is moving with respect to the structure meets the deactivation condition, the safety controller causes a blank display on the mobile display system when the speed at which the user is moving with respect to the structure meets the deactivation condition.

4. The safety enhancement system of claim 1, wherein in deactivating the visual display of the augmented reality information on the mobile display system when the speed at which the user is moving with respect to the structure meets the deactivation condition, the safety controller removes the visual display of the augmented reality information while continuing to display a live view when the speed at which the user is moving with respect to the structure meets the deactivation condition.

5. The safety enhancement system of claim 4, wherein the safety controller is configured to resume displaying the visual display of the augmented reality information when the speed at which the user is moving with respect to the structure no longer meets the deactivation condition.

6. The safety enhancement system of claim 1, wherein the sensor system is configured to measure a position of the user and generate position information, wherein the safety controller is configured to determine whether the user is in an undesired posture using the position information; determine whether the user has been in the undesired posture for a period of time that is greater than a posture threshold for the undesired posture; and generate a warning.

7. The safety enhancement system of claim 6, wherein the safety controller is configured to turn off the mobile display system if the user does not move out of the undesired posture after a selected period of time.

8. The safety enhancement system of claim 1, wherein the sensor system is configured to measure a position of the user and generate position information from the position measured for the user, and wherein the safety controller is configured to determine the position of the user with respect to the structure using the position information and the three-dimensional model; identify a number of hazardous locations for the structure using the three-dimensional model; and present an alert for a hazardous location in the number of hazardous locations when the user is within an undesired distance from the hazardous location using the position of the user with respect to the structure and the three-dimensional model.

9. The safety enhancement system of claim 1, wherein the sensor system is selected from at least one of an accelerometer, a gyroscope, a magnetometer, a global positioning system device, or a camera.

10. The safety enhancement system of claim 1, wherein the mobile display system is selected from a group comprising a head-mounted display, smart glasses, a mobile phone, and a tablet computer.

11. The safety enhancement system of claim 1, wherein the structure is selected from one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a house, a manufacturing facility, a manufacturing cell, an aircraft structure, a fuselage section, a wing, a wing box, an engine housing, and an aircraft in an uncompleted state.

12. A method for safety enhancement comprising:
receiving, by a safety controller, movement information for a user of a mobile display system that displays augmented reality information;
determining, by the safety controller, a speed at which the user is moving with respect to a structure using the movement information and a three-dimensional model of the structure; and
deactivating, by the safety controller, a visual display of the augmented reality information on the mobile display system when the speed at which the user is moving with respect to the structure meets a deactivation condition.

13. The method of claim 12 further comprising:
measuring, by a sensor system, movement of the user of the mobile display system that displays the augmented reality information; and
relaying, by the sensor system to the safety controller, the movement information about the user from measuring the movement for the user.

14. The method of claim 12 further comprising:
determining, by the safety controller, a location of the user with respect to the structure, wherein deactivating the visual display of the augmented reality information on the mobile display system comprises:
deactivating, by the safety controller, the visual display of the augmented reality information on the mobile display system when the speed at which the user is moving and a location of the user with respect to the structure meets the deactivation condition.

15. The method of claim 12, wherein deactivating, by the safety controller, the visual display of the augmented reality information on the mobile display system when the speed at which the user is moving with respect to the structure meets the deactivation condition comprises:
causing, by the safety controller, a blank display on the mobile display system when the speed at which the user is moving with respect to the structure meets the deactivation condition.

16. The method of claim 12, wherein deactivating, by the safety controller, the visual display of the augmented reality information on the mobile display system when the speed at which the user is moving with respect to the structure meets the deactivation condition comprises:
removing, by the safety controller, the visual display of the augmented reality information while continuing to display a live view when the speed at which the user is moving with respect to the structure meets the deactivation condition.

17. The method of claim 16 further comprising:
resuming, by the safety controller, displaying of the visual display of the augmented reality information when the speed indicates that the speed at which the user is moving with respect to the structure does not meet the deactivation condition.

18. The method of claim 12 further comprising:
measuring, by a sensor system, a position of the user;
relaying, by the sensor system, position information from the position measured for the user to the safety controller;
determining, by the safety controller, whether the user is in an undesired posture using the position information in the undesired posture for a period of time that is greater than a posture threshold for the undesired posture; and
generating a warning.

19. The method of claim 18 further comprising:
turning off, by the safety controller, the mobile display system if the user does not move out of the undesired posture after a selected period of time.

20. The method of claim 12 further comprising:
measuring, by a sensor system, a position of the user;
relaying, by the sensor system, position information from measuring the position of the user to the safety controller;
determining, by the safety controller, the position of the user with respect to the structure using the position information and the three-dimensional model;
identifying, by the safety controller, a number of hazardous locations for the structure using the three-dimensional model; and
generating, by the safety controller, an alert for a hazardous location in the number of hazardous locations when the user is within an undesired distance from the hazardous location using the position of the user with respect to the structure and the three-dimensional model.

21. The safety enhancement system of claim 1, wherein the deactivation condition requires the speed at which the user is moving with respect to the structure to exceed a speed threshold.

22. The method of claim 12, wherein the deactivation condition requires the speed at which the user is moving with respect to the structure to exceed a speed threshold.
